(19) United States
(12) Patent Application Publication
(10) Pub. No.: US 2011/0128164 A1
(43) Pub. Date: Jun. 2, 2011

(54) USER INTERFACE DEVICE FOR CONTROLLING CAR MULTIMEDIA SYSTEM

(75) Inventors: Sung Hyun Kang, Hwaseong (KR); Sang-Hyun Lee, Seoul (KR)

(73) Assignee: Hyundai Motor Company, Seoul (KR)

(21) Appl. No.: 12/753,944

(22) Filed: Apr. 5, 2010

(30) Foreign Application Priority Data
Dec. 2, 2009 (KR) 10-2009-0118642

(51) Int. Cl. G08G 1/123; G06F 3/041; G09G 5/02; G06F 3/048

(52) U.S. Cl. 340/995.16; 345/173; 345/589; 715/800

(57) ABSTRACT

The present invention features a user interface device for controlling a car multimedia system that preferably includes a remote touchpad unit, a display unit displaying various kinds of modes of a multimedia system in accordance with a three-dimensional signal received from the remote touchpad unit, and a control unit controlling to operate the multimedia system in accordance with the three-dimensional signal provided from the remote touchpad unit. According to the user interface device, it is possible to manipulate a multimedia system by a three-dimensional interaction using a remote touchpad unit to improve the utility. Accordingly, the danger of accident and the driver's loading can be suitably reduced.

### CROSS-REFERENCE TO RELATED APPLICATION

This application claims under 35 U.S.C. §119(a) the benefit of Korean Patent Application No. 10-2009-118642, filed on Dec. 2, 2009 in the Korean Intellectual Property Office, the disclosure of which is incorporated herein in its entirety by reference.

### BACKGROUND OF THE INVENTION

1. Field of the Invention

The present invention relates, generally, to a user interface device for controlling a car multimedia system, and more particularly, to a user interface device for controlling a car multimedia system, is which utilizes three-dimensional interaction.

2. Background Art

Recently, research has focused on input devices for car multimedia systems, and both car manufacturers and also aftermarkets have launched many devices.

Most input devices which have currently been launched correspond to products that utilize touch-based touch screens.

However, a conventional touch-oriented interaction occupies a driver's gaze during driving, and may put the driver in danger of an accident/ Thus, and even a simple manipulation of a touch-based system can be a burden on the driver.

Accordingly, there is a need in the art for user interface devices for controlling a car multimedia system.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a user interface device for controlling a car multimedia system, which makes it possible to manipulate a multimedia system by a three-dimensional interaction using a remote touchpad unit. In preferred embodiments, the user interface device of the present invention suitably improves the utility.

In preferred embodiments, the present invention provides a user interface device for controlling a car multimedia system, which preferably includes a remote touchpad unit; a display unit displaying various kinds of modes of a multimedia system in accordance with a three-dimensional signal received from the remote touchpad unit; and a control unit controlling to operate the multimedia system in accordance with the three-dimensional signal provided from the remote touchpad unit.

According to certain exemplary embodiments, it is preferable that the three-dimensional signal includes a wipe pass gesture that is suitably performed in a non-touch state with the remote touchpad unit, and the display unit displays a scene that corresponds to the wipe pass gesture.

According to further exemplary embodiments, it is preferable that the wipe pass gesture is possible between a first height from the remote touchpad unit and a second height that is higher than the first height.

According to other further exemplary embodiments, it is preferable that when an object is suitably positioned between the second height and a third height that is higher than the second height, the display unit displays a manipulation standby scene that meets the situation.

According to further exemplary embodiments, it is preferable that when the object is suitably positioned between the first height and a height that corresponds to a position just before the object becomes in touch with the remote touchpad unit, the position of the object is suitably displayed on the display unit, and in this case, the position of the object is activated as a highlight.

In further preferred embodiments, an illumination unit is displayed on the display unit, which suitably displays a corresponding scene with different brightness in accordance with the height of an object that approaches the remote touchpad unit.

Further, it is preferable that in a navigation mode, a map is suitably displayed on the display unit with zoom in stages in accordance with the height of an object that approaches the remote touchpad unit.

In another preferred embodiment, the present invention provides a user interface device for controlling a car multimedia system, which includes a remote touchpad unit; and a display unit displaying a state in accordance with a height (corresponding to a Z-axis signal) of an object in a non-touch state, which is suitably received from the remote touchpad unit.

According to further exemplary embodiments, t is preferable that the remote touchpad unit is provided with an illumination unit which suitably displays a corresponding scene with different brightness in accordance with the height (corresponding to a z-axis signal) of the object that approaches the remote touchpad unit, and the display unit displays another illumination unit that is linked with the illumination unit of the remote touchpad unit.

Further, it is preferable that in a navigation mode, if an object is made to approach the remote touchpad unit after entering into a magnifying glass mode through clicking of a magnifying glass icon, a map that is displayed on the display unit is suitably enlarged in stages at a predetermined zoom rate.

As described above, according to preferred embodiments of the present invention, it is possible to suitably manipulate a multimedia system by a three-dimensional interaction using a remote touchpad unit to improve the utility. Accordingly, the danger of accident during driving can be suitably reduced, and the driver's loading can also be suitably reduced.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two to or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more apparent from the following detailed description taken in conjunction with the accompanying drawings, in which:

FIG. 1 is a control block diagram of a user interface device for controlling a car multimedia system according to a preferred embodiment of the present invention;

FIG. 2 is a view illustrating an example of wipe pass gesture in a state where a user is in a non-touch state with a remote touchpad unit;

FIG. 3 is a view explaining effects caused by a height between a remote touchpad unit and a finger;

FIGS. 4A and 4B are views illustrating a change of a scene displayed on a display unit when a finger approaches a remote touchpad unit;

FIG. 5 is a view explaining a process in which a part corresponding to the position of a finger is activated as a highlight when the finger approaches a remote touchpad unit in a non-touch state with the remote touchpad unit;

FIG. 6 is a view explaining a process in which a corresponding is scene is displayed with different brightness in accordance with the height (corresponding to a z-axis signal) of the object that approaches a remote touchpad unit; and

FIGS. 7A and 7B is a view explaining a process of zooming in on a map in a navigation mode.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE PREFERRED EMBODIMENTS

As described herein, the present invention includes a user interface device for controlling a car multimedia system, comprising a remote touchpad unit that receives a three-dimensional signal, a display unit displaying modes of a multimedia system in accordance with the three-dimensional signal received from the remote touchpad unit, and a control unit controlling the multimedia system in accordance with the three-dimensional signal from the remote touchpad unit.

In one embodiment, the three-dimensional signal comprises a wipe pass gesture.

In another embodiment, the wipe pass gesture is performed in a non-touch state with the remote touchpad unit.

In another further embodiment, the display unit displays a scene that corresponds to the wipe pass gesture.

In another aspect, the present invention features a user interface device for controlling a car multimedia system, comprising a remote touchpad unit, and a display unit displaying a state in accordance with a height of an object in a non-touch state, wherein the height corresponds to a Z-axis signal, and wherein the signal is received from the remote touchpad unit.

The present invention also features a motor vehicle comprising the user interface device set forth in any one of the aspects described herein.

Hereinafter, preferred embodiments of the present invention will be described in greater detail with reference to the accompanying drawings. The matters defined in the description such as a detailed construction and elements are provided to assist in a comprehensive understanding of the invention. Thus, it is apparent that the present invention can be carried out without those defined matters. Also, well-known functions or constructions are not described in detail since they would obscure the invention in unnecessary detail. In the following description, the same reference numerals are used for the same elements even in different drawings.

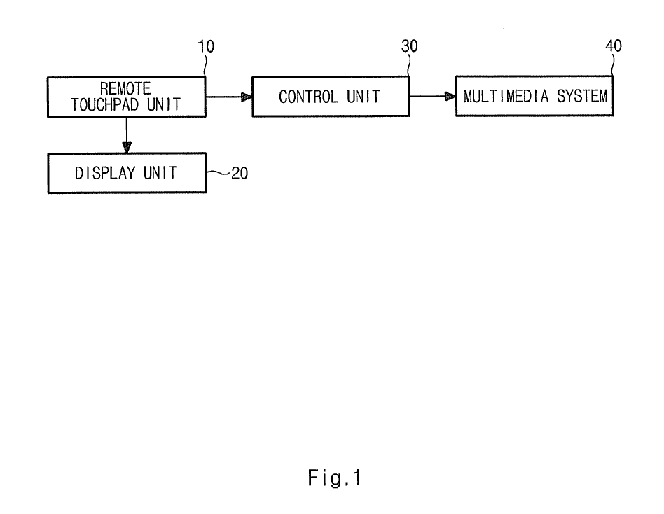

According to preferred embodiments of the present invention, a is user interface device for controlling a car multimedia system, for example as shown in FIG. 1, preferably includes a remote touchpad unit 10, a display unit 20, and a control unit 30.

In one preferred embodiment, a multimedia system 40 is suitably mounted in a vehicle to provide convenience to passengers, and is suitably configured to implement functions of audio, video, navigation, and the like.

Preferably, the remote touchpad unit 10 is an input device for remotely operating the multimedia system 40, and when a user touches or approaches the remote touchpad unit 10 with a finger or an object such as a pointer (hereinafter referred to as a “finger”), the remote touchpad unit 10 forms a suitable three-dimensional signal. Preferably, the three-dimensional signal from the remote touchpad unit 10 is suitably output to the display unit 20 and various kinds of modes of the multimedia system 40 desired by a user are suitably displayed.

In certain preferred embodiments of the present invention, it is preferable to use as the remote touchpad unit 10, a remote touchpad device disclosed in Korean Patent Application No. 2009-0086502 previously filed by the applicant and incorporated by reference in its entirety herein. However, it is to be understood that the remote touchpad unit 10 is not limited thereto, and any device that can suitably remotely transmit signals to the display unit 20 and the is control unit 30 can be used.

According to further preferred embodiments, the display unit 20 suitably displays various kinds of modes of the multimedia system 40, such as radio/media/phone/navigation/information modes, in accordance with the three-dimensional signal output from the remote touchpad unit 10.

Preferably, the three-dimensional signal is suitably obtained by calculating the position of a finger in X, Y, and Z-axis coordinates, and includes not only a signal in the case where the finger is in touch with the remote touchpad unit 10 (in this case, Z-axis coordinate=0) but also a signal in the case where the finger is not in touch with the remote touchpad unit 10 (in this case, Z-axis coordinate≠0).

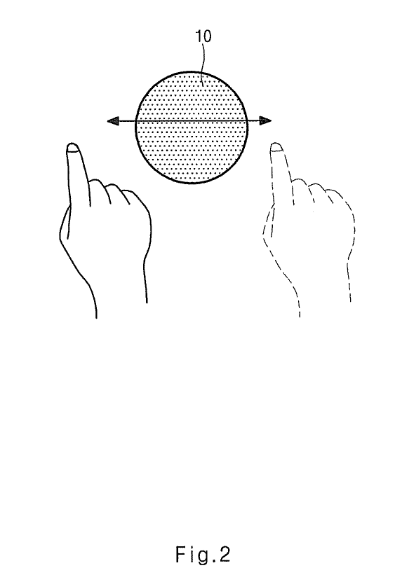

Accordingly, in further preferred embodiments, the three-dimensional signal preferably includes a wipe pass gesture that is suitably performed in the state where the finger is in non-touch with the remote touchpad unit 10. That is, as shown in FIG. 2, if a user moves a finger from right to left or from left to right in the state where the finger is kept apart from the remote touchpad unit 10 at a predetermined height, the display unit 20 suitably displays a scene which is shifted from a first mode to second mode (i.e. front key function) or from the second mode to the first mode (i.e. back key function). Preferably, after entering into the mode, the scene may be suitably shifted to home/main/sub scene in accordance with the wipe pass gesture.

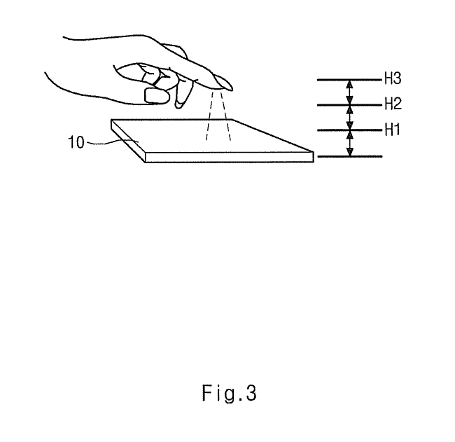

According to further preferred embodiments, the wipe pass gesture, for example as shown in FIG. 3, may be set so that it is possible between a first height H1 from the remote touchpad unit 10 and a second height H2 that is higher than the first height H1. In further embodiments, it is preferable that H1 and H2 are 3 cm and 5 dm, respectively, so that the wipe pass gesture is suitably performed within the height of 3 cm to 5 dm.

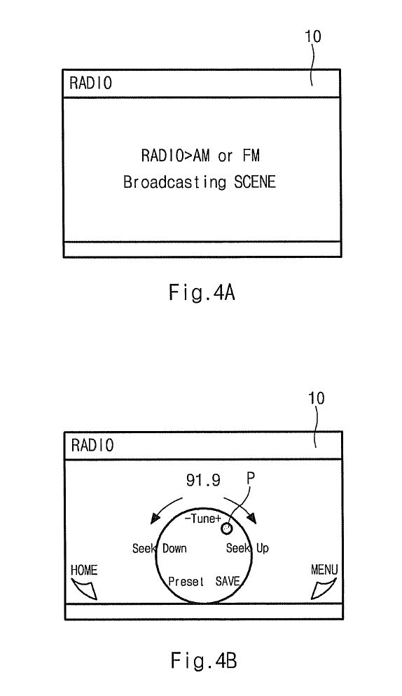

Preferably, when the finger is suitably positioned between the second height H2 from the remote touchpad unit 10 and a third height H3 that is higher than the second height H2, the display unit 20 displays a manipulation standby scene that meets the situation. Accordingly, it is preferable that H3 is 7 cm, and when the finger approaches the remote touchpad unit 10 along a Z-axis direction as shown in FIGS. 4A and 4B, and is positioned between 5 cm and 7 cm, the scene is suitably shifted from a radio main scene as shown in FIG. 4A to a manipulation standby scene as shown in FIG. 4B.

In other preferred embodiments of the present invention, when the finger is suitably positioned between the first height H1 and a height that corresponds to a position just before the finger becomes in touch with the remote touchpad unit 10, the position P of the finger that corresponds to the direction of the finger sensed by the remote touchpad unit 10 is displayed on the display unit 20. Preferably, in this section, i.e. non-touch distance to 3 cm, for example, it is possible to make a fine manipulation that can move the pointer on the map in the navigation mode or can move a menu. Accordingly, it is preferable that the position P of the finger that is displayed on the display unit 20 is activated as a highlight, and thus the user can easily recognize the finger position.

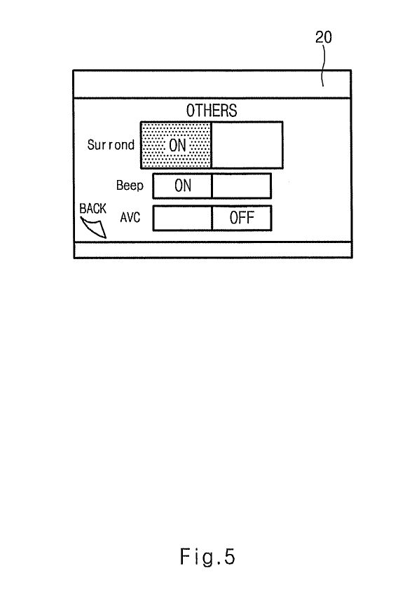

In further exemplary embodiments, for example as shown in FIG. 5, when the user makes the finger approach the remote touchpad 10 to select an arbitrary item, the finger approaching direction is judged in a state where the finger is in non-touch with the remote touchpad 10, and the selectable items are suitably activated (e.g., surround “ON” portion) as a highlight to facilitate the item selection.

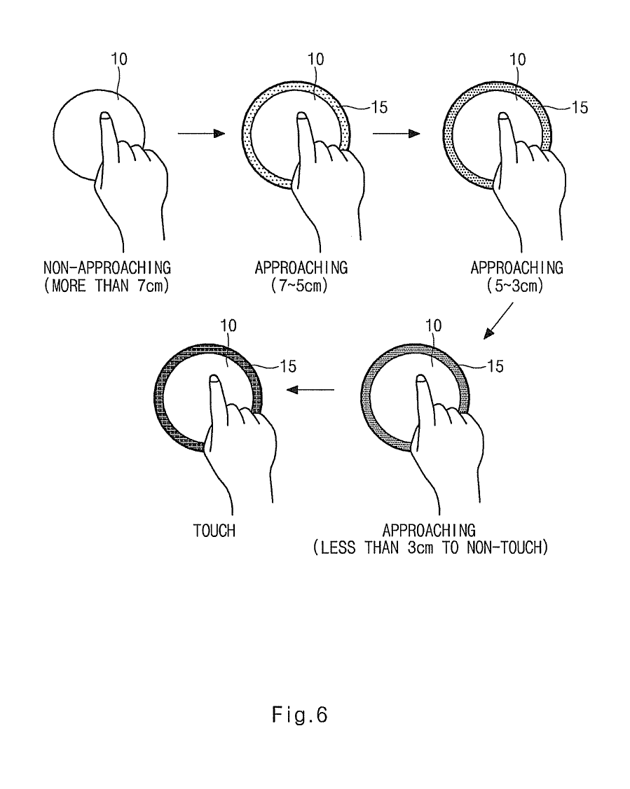

In still further exemplary embodiments, it is preferable that an illumination unit (not illustrated) is suitably displayed on the display unit 20, which displays a corresponding portion of a scene with different brightness in accordance with the height of the finger that approaches the remote touchpad unit 10. FIG. 6, for example, shows that the brightness of the illumination unit 15 on the border of the remote touchpad unit 10 becomes different when the finger approaches the remote touchpad unit 10 in Z-axis direction. Accordingly, not only the illumination unit in the remote touchpad unit 10 but also the illumination unit in the display unit 20 is suitably displayed, and thus the user can easily recognize to what extent the finger is approaching the remote touchpad unit 10. For example, if the finger is at the height that exceeds 7 cm from the remote touchpad unit 10, the illumination unit that is displayed on the display unit 20 is in an off state. Preferably, in this state, as the finger approaches the remote touchpad unit 10 in Z-axis direction, the color is of the illumination unit of the display unit 20 becomes deeper in stages, and when the finger becomes in touch with the remote touchpad unit 10, the illumination unit of the display unit 20 displays a different color.

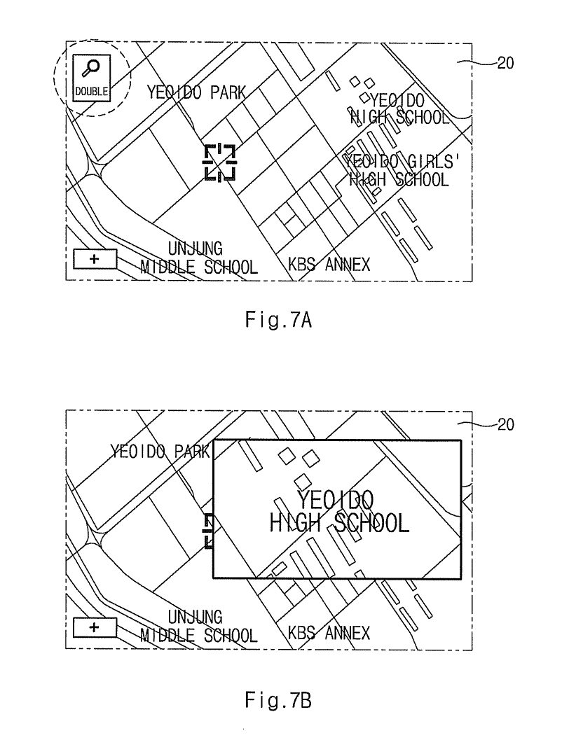

In other exemplary embodiments, in a navigation mode, for example as shown in FIGS. 7A and 7B, a map is suitably displayed on the display unit 20 with zoom in stages in accordance with the height of the finger that approaches the remote touchpad unit 10.

In particular, if a user clicks a magnifying glass icon that is displayed as shown for example in FIG. 7A, the device enters into a magnifying glass mode. Preferably, if a user moves the finger to a desired position and changes the height of the finger approaching the remote touchpad unit 10, the map is suitably enlarged in stages at a zoom rate set by the user. For example, as the finger becomes nearer to the remote touchpad unit 10, the map is suitably enlarged two times, four times, six times, and the like.

In other exemplary embodiments, if the finger is further far apart from the remote touchpad unit 10 over a predetermined height (e.g. about 7 cm), the map is shown in a normal mode. Preferably, in this state, if the user clicks again the magnifying glass icon, the map returns to a normal mode, and thus the user can use another mode.

As described herein, according to the present invention, it is possible to manipulate the multimedia system 40 by a three-dimensional interaction using the remote touchpad unit 10 to suitably improve the utility. Accordingly, in preferred embodiments of the is present invention as described herein, the danger of accident during driving can be reduced, and the driver's loading can also be reduced.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A user interface device for controlling a car multimedia system, comprising:
a remote touchpad unit;
a display unit displaying various kinds of modes of a multimedia system in accordance with a three-dimensional signal received from the remote touchpad unit; and
a control unit controlling the multimedia system in accordance with the three-dimensional signal provided from the remote touchpad to unit.

2. The user interface device according to claim 1, wherein the three-dimensional signal comprises a wipe pass gesture that is performed in a non-touch state with the remote touchpad unit, and
wherein the display unit displays a scene that corresponds to the wipe pass gesture.

3. The user interface device according to claim 2, wherein the wipe pass gesture is performed between a first height from the remote touchpad unit and a second height that is higher than the first height.

4. The user interface device according to claim 3, wherein when an object is positioned between the second height and a third height that is higher than the second height, the display unit displays a manipulation standby scene.

5. The user interface device according to claim 4, wherein when the object is positioned between the first height and a height that corresponds to a position just before the object touches the remote touchpad unit, the position of the object is displayed on the display unit.

6. The user interface device according to claim 5, wherein the position of the object is activated as a highlight on the display unit.

7. The user interface device according to claim 1, wherein an illumination unit is displayed on the display unit, which displays a corresponding scene with different brightness in accordance with the is height of an object that approaches the remote touchpad unit.

8. The user interface device according to claim 1, wherein in a navigation mode, a map is displayed on the display unit with zoom in stages in accordance with the height of an object that approaches the remote touchpad unit.

9. A user interface device for controlling a car multimedia system, comprising:
a remote touchpad unit; and
a display unit displaying a state in accordance with a height of an object in a non-touch state, wherein the height corresponds to a Z-axis signal, and wherein the signal is received from the remote touchpad unit.

10. The user interface device according to claim 9, wherein the remote touchpad unit is provided with an illumination unit which displays a corresponding scene with different brightness in accordance with the height of the object that approaches the remote touchpad unit, and
the display unit displays another illumination unit that is linked with the illumination unit of the remote touchpad unit.

11. The user interface device according to claim 9, wherein in a navigation mode, if an object is made to approach the remote touchpad unit after entering into a magnifying glass mode through clicking of a magnifying glass icon, a map that is displayed on the display unit is enlarged in stages at a predetermined zoom rate.

12. A user interface device for controlling a car multimedia system, comprising:
a remote touchpad unit that receives a three-dimensional signal;
a display unit displaying modes of a multimedia system in accordance with the three-dimensional signal received from the remote touchpad unit; and
a control unit controlling the multimedia system in accordance with the three-dimensional signal from the remote touchpad unit.

13. The user interface device according to claim 12, wherein the three-dimensional signal comprises a wipe pass gesture.

14. The user interface device according to claim 12, wherein the wipe pass gesture is performed in a non-touch state with the remote touchpad unit.

15. The user interface device according to claim 12, wherein the display unit displays a scene that corresponds to the wipe pass gesture.

16. A motor vehicle comprising the user interface device of claim 1.

17. A motor vehicle comprising the user interface device of claim 12.
